(19) United States
(12) Patent Application Publication
(10) Pub. No.: US 2021/0319289 A1
(43) Pub. Date: Oct. 14, 2021

(54) FREQUENCY DOMAIN NEURAL NETWORK ACCELERATOR

(71) Applicant: ALIBABA GROUP HOLDING LIMITED, George Town (KY)

(72) Inventors: Wei HAN, San Mateo, CA (US); Xiaoxin FAN, San Mateo, CA (US); Yuhao WANG, San Mateo, CA (US)

(21) Appl. No.: 16/846,966

(22) Filed: Apr. 13, 2020

(51) Int. Cl. G06N 3/04; G06F 17/14; G06F 7/523; G06N 3/063

(52) U.S. Cl. CPC G06N 3/0481; G06N 3/063; G06F 7/523; G06F 17/141

(57) ABSTRACT

The present disclosure relates to systems and methods concerning a system including a host device and a convolutional neural network hardware accelerator. The hardware accelerator can be configured, at least in part by the host device, to generate activation data from spatial-domain input data and spatial-domain weight data using frequency-domain operations. The hardware accelerator can include one or more discrete Fourier transform units configured to generate a frequency-domain representation of the input data. The hardware accelerator can include a multiplication unit configured to generate a frequency-domain representation of the activation data by element-wise complex multiplication of the frequency-domain representation of the input data and a frequency-domain representation of the weight data. The hardware accelerator can also include an inverse discrete Fourier transform unit configured to generate a spatial-domain representation of the activation data from the frequency-domain representation of the activation data.

### BACKGROUND

Convolutional neural networks (CNNs) can be used for a variety of applications, including image processing and analysis applications such as image segmentation, object detection, and object classification. However, increasingly sophisticated applications may require increasingly bigger and more complicated CNN models. Such models may require more computational resources and time for training and inference tasks. Traditional hardware accelerators designed without reference to the particular structure of convolutional neural networks are ill-suited for convolutional neural network applications. Architectural approaches to reducing computational resources and time, such as using smaller weight matrices or adding pooling layers, limit the architectures available to developers. Furthermore, as CNN models continue to become bigger and more complicated, such architecture approaches may exhibit diminishing returns.

### SUMMARY OF THE DISCLOSURE

Embodiments of the present disclosure provide systems and methods concerning convolutional neural network (CNN) hardware accelerators. The disclosed CNN hardware accelerators can be configured to perform operations in the frequency domain, reducing the computational time and resources required to generate the output of a convolutional layer in a convolutional neural network.

The disclosed embodiments include a device. The device can include a convolutional neural network hardware accelerator configured to generate activation data from spatial-domain input data and spatial-domain weights data using frequency-domain operations. The convolutional neural network hardware accelerator can include one or more discrete Fourier transform units including circuitry configured to generate a frequency-domain representation of the input data. The device can further include a multiplication unit including circuitry configured to generate a frequency-domain representation of the activation data by element-wise complex multiplication of the frequency-domain representation of the input data and a frequency-domain representation of the weights data. The device can additionally include an inverse discrete Fourier transform unit including circuitry configured to generate a spatial-domain representation of the activation data from the frequency-domain representation of the activation data.

The disclosed embodiments can include a method for calculating activation data for a convolutional neural network layer using frequency-domain operations. The method can include obtaining, by a hardware accelerator, spatial-domain input data and spatial-domain weight data for the convolutional neural network layer. The method can further include converting, by the hardware accelerator, the spatial-domain input data and spatial-domain weight data into a frequency-domain representation of the input data and a frequency-domain representation of the weight data. The method can also include generating, by the hardware accelerator, a frequency-domain representation of activation data by element-wise complex multiplication of the frequency-domain representation of the input data and the frequency-domain representation of the weight data. The method can additionally include converting, by the hardware accelerator, the frequency-domain representation of the activation data into a spatial-domain representation of the activation data.

The disclosed embodiments include a system. The system can include a host device. The system can also include a convolutional neural network hardware accelerator. The convolutional neural network hardware accelerator can be configured, at least in part by the host device, to generate activation data from spatial-domain input data and spatial-domain weights data using frequency-domain operations. The convolutional neural network hardware accelerator can include one or more discrete Fourier transform units including circuitry configured to generate a frequency-domain representation of the input data. The convolutional neural network hardware accelerator can further include a multiplication unit including circuitry configured to generate a frequency-domain representation of the activation data by element-wise complex multiplication of the frequency-domain representation of the input data and a frequency-domain representation of the weights data. The convolutional neural network hardware accelerator can also include an inverse discrete Fourier transform unit including circuitry configured to generate a spatial-domain representation of the activation data from the frequency-domain representation of the activation data. The convolutional neural network hardware accelerator can also include a first non-linear function unit including circuitry configured to apply a first function to the frequency-domain representation of the input data, or a second non-linear function unit including circuitry configured to apply a second function to the frequency-domain representation of the activation data.

The disclosed embodiments include a non-transitory computer-readable medium. The non-transitory computer-readable medium can include instructions that, when executed by a convolutional neural network hardware accelerator, cause the convolutional neural network hardware accelerator to perform operations. The operations can include obtaining, by the convolutional neural network hardware accelerator, spatial-domain input data and spatial-domain weight data for a convolutional neural network layer. The operations can further include converting, by a discrete Fourier transform unit of the convolutional neural network hardware accelerator, the spatial-domain input data and spatial-domain weight data into a frequency-domain representation of the input data and a frequency-domain representation of the weight data. The operations can additionally include generating, by a SIMD unit of the convolutional neural network hardware accelerator, a frequency-domain representation of intermediate data by element-wise complex multiplication of the frequency-domain representation of the input data and the frequency-domain representation of the weight data. The operations can also include generating, by a non-linear function unit of the convolutional neural network hardware accelerator, a frequency-domain representation of activation data by applying a second function to the frequency-domain representation of the intermediate data. The operations can further include converting, by a inverse discrete Fourier transform unit of the convolutional neural network hardware accelerator, the frequency-domain representation of the activation data into a spatial-domain representation of the activation data.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 illustrates exemplary generation of neural network outputs using frequency domain operations, in accordance with disclosed embodiments.

FIG. 2A illustrates an exemplary neural network accelerator architecture, in accordance with disclosed embodiments.

FIG. 2B illustrates an exemplary neural network accelerator core architecture, in accordance with disclosed embodiments.

FIG. 2C illustrates a schematic diagram of an exemplary cloud system incorporating a neural network accelerator, in accordance with disclosed embodiments.

FIG. 3 illustrates an exemplary operation unit configuration, in accordance with disclosed embodiments.

FIG. 4 illustrates an exemplary method for generating a neural network layer output using frequency domain operations, in accordance with disclosed embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The disclosed systems and methods include improved hardware accelerators for use in implementing convolutional neural networks. These convolutional neural network (CNN) hardware accelerators can be configured to generate CNN outputs using frequency domain operations, rather than spatial domain operations. Because such frequency domain operations may be less computationally complex than equivalent spatial domain operations, the CNN accelerators may exhibit improvements in computation speed and reductions in power usage over traditional CNN hardware accelerators.

Traditional CNN accelerators convolve the input data with weights in the spatial domain to generate output values. Convolution is computationally intensive: convolution of an N×N input data matrix with a K×K weights matrix has a computational complexity of 0(N²K²). Furthermore, matrix convolution can be difficult to implement efficiently. For example, the data flow and reordering necessary to perform efficient matrix convolution can burden the controller of a hardware accelerator or the software/compiler responsible for configuring the hardware accelerator. The computational requirements of convolution can be reduced by using smaller input data or weight matrices, using pooling layers, or similar techniques. However, such architectural restrictions may limit designers of neural networks to potentially sub-optimal designs.

The disclosed CNN accelerators can convert input data and weight matrices from the spatial domain to the frequency domain. In place of convolution in the spatial domain, the disclosed CNN accelerators can perform pointwise multiplication in the frequency domain. In some embodiments, the computational complexity of conversion from the time domain to the frequency domain (for both weights and inputs) and conversion back from the frequency domain to the time domain can be 0(N² log N), while the computational complexity of pointwise multiplication can be 0(N²). In various embodiments, depending on architecture of the accelerator, the computational complexity may be more or less than 0(N² log N). Accordingly, the disclosed CNN accelerators can generate outputs in fewer operations than traditional CNN accelerators. As a result, the disclosed CNN accelerators can exhibit improved computational speed or reduced power or computational resource requirements.

The disclosed CNN accelerators can be configured with components supporting improved frequency domain operations, in accordance with disclosed embodiments. Such components can include blocks for converting data between the spatial and frequency domains. The blocks can be software configurable to accept inputs of varying sizes. In some embodiments, the blocks can be further software configurable to generate outputs of varying sizes (which may or may not be determined by the size of the inputs). Such software-configurable input and output sizes can permit use of the disclosed CNN accelerators existing applications with widely varying ranges of input sizes (e.g., ResNet-50 may be configured to use 224×224 layers, while DeepSpeech2 may be configured to use 700×161 layers). In some instances, an existing application may use the disclosed CNN accelerators without substantial modification, as the disclosed CNN accelerators can be configured to use the input and weights data sizes of the existing application. Furthermore, designers may not need to consider input data and weight sizes when designing applications for implementation on the disclosed CNN hardware accelerators.

The components of the CNN accelerator can include a multiplication unit, in accordance with disclosed embodiments. As would be appreciated by those of skill in the art, the frequency domain input data and weights can be complex-valued. While some conventional multiplication units can require four multiplication operations to determine the product of two complex numbers, the multiplication unit included in the CNN accelerator can be configured to determine the product of two complex numbers in a single operation. Furthermore, the multiplication unit can be configured to multiply pairs of complex numbers in parallel. By generating outputs in fewer operations and parallelizing generation of outputs, the multiplication unit can improve computation speed while reducing computation resources.

The components of the CNN accelerator can further include one or more non-linear function units, in accordance with disclosed embodiments. The non-linear function units can be configured to operate on input(s) or output(s) to the multiplication unit. The non-linear function units can support frequency-domain filtering (e.g., high-pass filtering), pooling, dropout, and similar operations. In some embodiments, the non-linear function units can support frequency-domain activation functions (e.g., Rectified Linear Unit (ReLU), leaky ReLU, hyperbolic tangent (Tan h), sigmoid, or the like). Such frequency domain operations can enable a neural network designer to use information embedded in the frequency-domain values. For example, in some applications, the lower spatial frequencies may correspond to less-useful information than the high spatial frequencies. Accordingly, in such applications, high-pass filtering spatial frequencies in either the frequency-domain output data or the frequency-domain version of the input data may improve convolutional neural network performance. In various embodiments, the non-linear function units can apply frequency domain versions of spatial-domain activation functions (e.g., Rectified Linear Unit (ReLU), leaky ReLU, Tanh, sigmoid, or the like) to frequency domain data. In this manner, the disclosed CNN accelerator can perform typical operations of a CNN layer (e.g., convolution of input data and weights, application of an activation function) entirely in the frequency domain. The disclosed CNN accelerators may therefore transparently implement existing applications (which may include operations specified in the spatial domain). Users can therefore experience improvements in computational speed and reductions in computational resource requirements without knowing that the hardware accelerators operate in the frequency domain or having to modify existing applications.

Accordingly, as described herein, the disclosed CNN hardware accelerators can improve upon conventional systems by performing operations in the frequency domain. The disclosed CNN hardware accelerators can include, in accordance with disclosed embodiments, at least one of conversion block(s), multiplication unit(s), or non-linear function unit(s). These components can improve the flexibility of the disclosed CNN hardware accelerators, permitting use in existing applications, and improve computation speed while reducing computation resources, as compared to conventional designs.

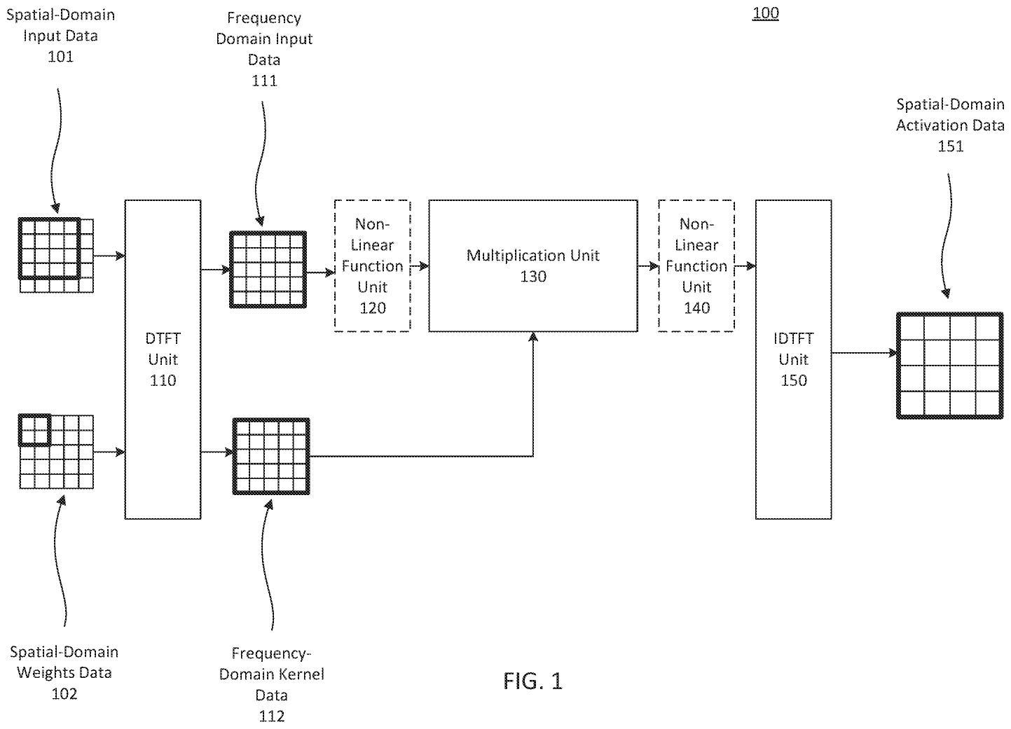

FIG. 1 illustrates exemplary generation of neural network outputs by CNN accelerator 100 using frequency domain operations, in accordance with disclosed embodiments. As depicted in FIG. 1, CNN accelerator 100 can include components such as conversion blocks for converting between the spatial domain and the frequency domain (e.g., discrete time Fourier transform (DTFT) unit 110 and inverse discrete time Fourier transform (IDTFT) unit 150), non-linear function units (e.g., non-linear function units 120 and 140), and one or more multiplication units (e.g., multiplication unit 130). The components of CNN accelerator 100 can convert spatial domain inputs (e.g., spatial-domain input data 101 and spatial-domain kernel data 102) into frequency domain data (e.g., frequency-domain input data 111 and frequency-domain kernel data 112). The frequency domain data can be processed by the one or more multiplication units, non-linear function units, and conversion block to generate spatial-domain output data (e.g., spatial domain activation data 151).

DTFT unit 110 can include circuitry configurable to convert inputs to CNN accelerator 100 from the spatial domain to the frequency domain. In some embodiments, DTFT unit 110 can include at least one fast Fourier transform (FFT) block for converting the input data and weight matrices into frequency domain matrices. The at least one FFT block can be software-configurable to accept varying input sizes (e.g. 4×4, 256×256, or the like). In some embodiments, each of the at least one FFT blocks can be configured to accept varying input sizes using settable register values in CNN accelerator 100. In some embodiments, each of the at least one fast Fourier transform blocks can include at least one butterfly unit and memory. In some implementations, the at least one butterfly unit can be configured to iteratively generate the FFT of the input data. In each iteration, the butterfly unit can obtain input data from the memory, combine the input data using the butterfly unit to generate output data according to an FFT algorithm, and store the output data in the memory. This process can be repeated in the next iteration until the frequency domain data has been generated. The input data can be combined according to a decimation in time or decimation in frequency algorithm (e.g., the Cooley-Tukey algorithm or a variant thereof), or a similar FFT algorithm. In some implementations, the butterfly unit can be organized as a pipeline. The spatial-domain input data can be input to the butterfly unit and progress through the pipeline. The frequency-domain representation of the input data can be obtained from the butterfly unit at the end of the pipeline. The particular implementation of the FFT unit can depend on the amount of data to be processed and the speed of processing: a pipeline implementation may be less flexible and require more computational resources than an iterative implementation, but may enable concurrent processing of input data. For example, a pipeline implementation may enable conversion of the next input data to begin while the current input data is still being converted. As a result, a pipeline implementation may offer greater bandwidth than an iterative implementation.

As shown in FIG. 1, DTFT unit 110 can obtain spatial-domain input data 101 and spatial-domain kernel data 102. In some embodiments, the spatial-domain input data 101 and spatial-domain kernel data 102 can be converted to an equal input size. The conversion can be performed using zero-padding, interpolation, or a like method. In some embodiments, the input size can be based on the input sizes of spatial-domain input data 101 and spatial-domain kernel data 102. In some embodiments, when spatial-domain input data 101 has dimensions N×N and spatial-domain kernel data 102 has dimensions K×K, the converted, frequency-domain data can have dimensions N+K−1×N+K−1. In the non-limiting example shown in FIG. 1, spatial-domain input data 101 is increased from a 4×4 matrix to a 5×5 matrix and spatial-domain kernel data 102 is increased from a 2×2 matrix to a 5×5 matrix. Both matrices are then input to DTFT unit 110 to generate to 5×5 frequency-domain matrices. Other padding approximations can also be used, and the disclosed embodiments are not limited to any particular approximation.

In some embodiments, the operation of DTFT unit 110 can depend on whether CNN accelerator 100 is being used in an inference or training application. In an inference application, the spatial-domain input data 101 can vary, while spatial-domain kernel data 102 may remain the same. In such an application, DTFT unit 110 can be configured to convert the spatial-domain kernel data 102 each time new spatial-domain input data 101 is obtained, convert the spatial-domain kernel data 102 only the first time it is obtained, or never convert the spatial-domain kernel data 102 (e.g., when CNN accelerator 100 obtains frequency-domain kernel data 112 from another source). In some embodiments, CNN accelerator 100 can convert the spatial-domain kernel data 102 in a configuration mode and convert spatial-domain input data 101 in a run-time mode. In a training application, both spatial-domain input data 101 and spatial-domain kernel data 102 can vary. In such an application, DTFT unit 110 can be configured to convert the spatial-domain kernel data 102 each time new spatial-domain input data 101 is obtained. Alternatively, when weights are updated in the frequency domain during training, DTFT unit 110 may convert the spatial-domain kernel data 102 only the first time it is obtained, or never convert the spatial-domain kernel data 102.

CNN accelerator 100 can include non-linear function blocks, in accordance with disclosed embodiments. Such non-linear function blocks can include circuitry configurable to apply non-linear functions to the frequency domain input or weight matrices (e.g., non-linear function unit 120) or to an intermediate result to generate an output of the CNN hardware accelerator (e.g., non-linear function unit 140). The non-linear functions can include frequency-domain functions, such as frequency-domain activation functions (e.g., as described herein), filtering functions, dropout functions, or pooling functions (e.g., max pooling, average pooling, or the like); or frequency-domain versions of spatial-domain functions (e.g., as described herein). In some embodiments, the non-linear function blocks can be implemented using lookup tables or stored values.

CNN accelerator 100 can include multiplication unit 130, in accordance with disclosed embodiments. Multiplication unit 130 can include circuitry configurable to perform pointwise multiplication between the output of non-linear function unit 120 (or frequency-domain input data 111 when non-linear function unit 120 is absent or bypassed) and frequency-domain kernel data 112. Multiplication unit 130 can be implemented using a Single Instruction Multiple Data (SIMD) architecture that enables parallel performance of the same operation on multiple inputs, in accordance with disclosed embodiments. The inputs to multiplication unit 130 can be complex-valued. Accordingly, multiplication unit 130 can be configured to perform complex-valued multiplication on multiple input values at the same time. For example, multiplication unit 130 can include multiple complex multiplier blocks. Each complex multiplier block can include multipliers and adders. For example, in accordance with known methods of complex multiplication, a complex multiplier block can include four multipliers and two adders or three multipliers and four adders. Each complex multiplier block can be configured to multiply one element in the output of non-linear function unit 120 (or frequency-domain input data 111 when non-linear function unit 120 is absent or bypassed) and one corresponding element in frequency-domain kernel data 112. The complex multiplier block can be configured to perform complex multiplication in a single operation (i.e., without having to iteratively evaluate each component of the product of two complex numbers). In contrast, for two complex numbers, a conventional multiplier might be instructed to calculate the products of the real parts, the real and complex parts, and the complex parts. In such embodiments, calculating each product may constitute an operation. In various embodiments, combining the resulting products may require further addition operations. It can be appreciated that by avoiding such repeated operations, multiplication unit 130 can improve the computational speed CNN accelerator 100, at the expense of increased computational resources.

The disclosed embodiments are not limited to embodiments including a multiplication unit configured for complex multiplication. In some embodiments, depending on performance and cost requirements, CNN accelerator 100 can use a multiplication unit can include circuitry configurable to perform real-valued multiplication. In various embodiments, the conversion blocks can be reused to perform complex-valued multiplication. For example, an FFT block in DTFT unit 110 may be configured to perform pointwise multiplication between elements of the output of non-linear function unit 120 (or frequency-domain input data 111 when non-linear function unit 120 is absent or bypassed) and corresponding elements in frequency-domain kernel data 112. In such embodiments, the elimination of multiplication unit 130 may reduce the size and cost of CNN accelerator 100.

CNN accelerator 100 can include, in some embodiments, a conversion block (e.g., IDTFT unit 150) for converting intermediate data in the frequency domain into output data (e.g., activation values, or the like) in the spatial domain. The conversion block can include circuitry configurable to perform an inverse discrete time Fourier transform. As would be appreciated by those of skill in the art, FFT blocks with modified weights can be used to perform the inverse discrete time Fourier transform. Accordingly, in some embodiments, the conversion block can be implemented using at least one FFT block. Each of the at least one FFT blocks can be software-configurable to accept varying input sizes (e.g. 4×4, 256×256, or the like) or produce varying output sizes. In some embodiments, each of the at least one FFT blocks can be configured to accept varying input sizes using settable register values in CNN accelerator 100. Similar to the at least one FFT block implementing DTFT unit 110 in some embodiments, each of the at least one FFT block implementing IDTFT unit 150 can include at least one butterfly unit and a memory. The at least one FFT block implanting IDTFT unit 150 can be configured to generate output data from intermediate data received from multiplication unit 130 or non-linear function unit 140. The at least one FFT block can be configured to generate the output data iteratively or using a pipeline, similar to the FFT blocks described above with regards to DTFT unit 110. As described above, incorporating software-configurable FFT blocks (or inverse FFT blocks) capable of accepting varying input sizes can enable use of CNN accelerator 100 with existing applications having differing input sizes and reduce restrictions on the design of new applications.

The particular arrangement of components and functionality displayed in FIG. 1 is not intended to be limiting. In various embodiment, CNN accelerator 100 may not include (or may be configured to bypass) at least one of the conversion blocks or non-linear function units. Such reduced implementations may provide performance improvements in particular applications or architectures. CNN accelerator 100 may not include (or may be configured to bypass) at least one of the non-linear function blocks when such functions are not implemented (or implemented elsewhere) in the convolutional neural network architecture. CNN accelerator 100 may not include (or may be configured to bypass) at least one of the conversion blocks when input data is received or output data is provided in the frequency domain. For example, in some implementations, sequential layers of a convolutional neural network may be implemented in the frequency domain. In such implementations, a convolutional layer may obtain input data in the frequency domain and provide output data in the frequency domain to the next convolutional layer. CNN accelerator 100 can be configured to support such implementations by enabling input data or output data to bypass the conversion blocks (e.g., bypassing the DTFT unit 110 or IDTFT unit 150). For example, when input data is received as frequency domain data, CNN accelerator 100 may not include (or may not be configured to use) DTFT unit 110. As an additional example, when CNN accelerator 100 outputs frequency domain data, CNN accelerator 100 may not include (or may not be configured to use) IDTFT unit 150. Embodiments not including or bypassing conversion blocks may provide improved performance when sequential layers of a convolutional neural network are implemented in the frequency domain. In such implementations, operating entirely in the frequency domain can avoid incurring the time and resources required to convert data to or from the spatial domain.

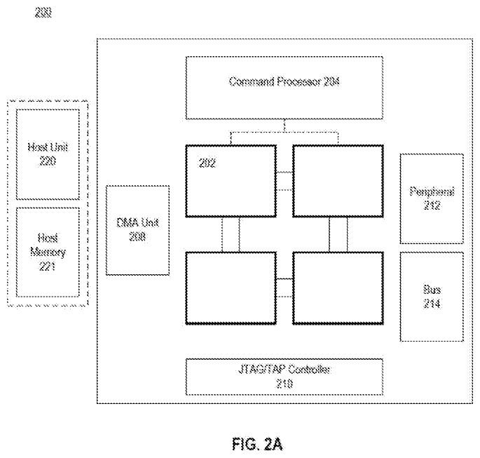

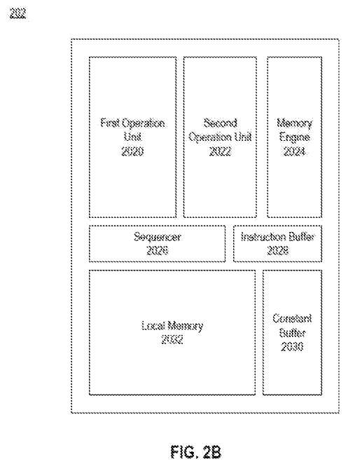

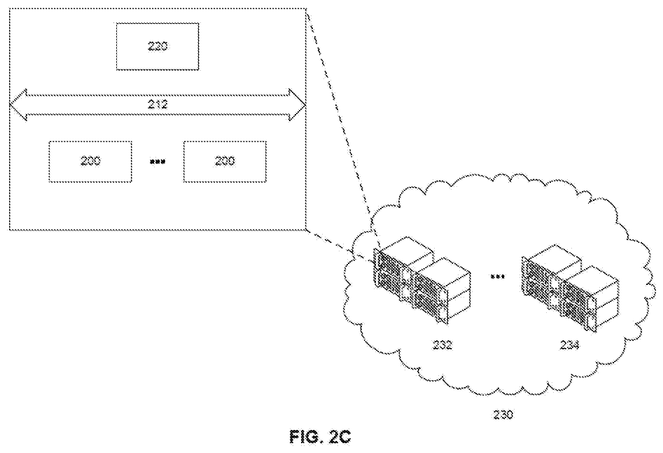

FIG. 2A illustrates an exemplary CNN accelerator architecture, consistent with embodiments of the present disclosure. In the context of this disclosure, a CNN accelerator may also be referred to as a machine learning accelerator or deep learning accelerator. In some embodiments, accelerator architecture 200 may be referred to as a neural network processing unit (NPU) architecture 200. As shown in FIG. 2A, accelerator architecture 200 can include a plurality of cores 202, a command processor 204, a direct memory access (DMA) unit 208, a Joint Test Action Group (JTAG)/Test Access End (TAP) controller 210, a peripheral interface 212, a bus 214, and the like.

It is appreciated that, cores 202 can perform algorithmic operations based on communicated data. Cores 202 can include one or more processing elements that may include single instruction, multiple data (SIMD) architecture including one or more processing units configured to perform one or more operations (e.g., multiplication, complex multiplication, addition, multiply-accumulate, etc.) based on commands received from command processor 204. To perform the operation on the communicated data packets, cores 202 can include one or more processing elements for processing information in the data packets. Each processing element may comprise any number of processing units. According to some embodiments of the present disclosure, accelerator architecture 200 may include a plurality of cores 202, e.g., four cores. In some embodiments, the plurality of cores 202 can be communicatively coupled with each other. For example, the plurality of cores 202 can be connected with a single directional ring bus, which supports efficient pipelining for large neural network models. The architecture of cores 202 will be explained in detail with respect to FIG. 2B.

Command processor 204 can interact with a host unit 220 and pass commands and data to corresponding core 202. In some embodiments, command processor 204 can interact with host unit under the supervision of kernel mode driver (KMD). In some embodiments, command processor 204 can modify the commands to each core 202, so that cores 202 can work in parallel as much as possible. The modified commands can be stored in an instruction buffer. In some embodiments, command processor 204 can be configured to coordinate one or more cores 202 for parallel execution.

DMA unit 208 can assist with transferring data between host memory 221 and accelerator architecture 200. For example, DMA unit 208 can assist with loading data or instructions from host memory 221 into local memory of cores 202. DMA unit 208 can also assist with transferring data between multiple accelerators. DMA unit 208 can allow off-chip devices to access both on-chip and off-chip memory without causing a host CPU interrupt. In addition, DMA unit 208 can assist with transferring data between components of accelerator architecture 200. For example, DMA unit 208 can assist with transferring data between multiple cores 202 or within each core. Thus, DMA unit 208 can also generate memory addresses and initiate memory read or write cycles. DMA unit 208 also can contain several hardware registers that can be written and read by the one or more processors, including a memory address register, a byte-count register, one or more control registers, and other types of registers. These registers can specify some combination of the source, the destination, the direction of the transfer (reading from the input/output (I/O) device or writing to the I/O device), the size of the transfer unit, or the number of bytes to transfer in one burst. It is appreciated that accelerator architecture 200 can include a second DMA unit, which can be used to transfer data between other accelerator architectures to allow multiple accelerator architectures to communicate directly without involving the host CPU.

JTAG/TAP controller 210 can specify a dedicated debug port implementing a serial communications interface (e.g., a JTAG interface) for low-overhead access to the accelerator without requiring direct external access to the system address and data buses. JTAG/TAP controller 210 can also have on-chip test access port interface (e.g., a TAP interface) that implements a protocol to access a set of test registers that present chip logic levels and device capabilities of various parts.

Peripheral interface 212 (such as a PCIe interface), if present, serves as an (and typically the) inter-chip bus, providing communication between the accelerator and other devices (e.g., a host system).

Bus 214 (such as a I2C bus) includes both intra-chip bus and inter-chip buses. The intra-chip bus connects all internal components to one another as called for by the system architecture. While not all components are connected to every other component, all components do have some connection to other components they need to communicate with. The inter-chip bus connects the accelerator with other devices, such as the off-chip memory or peripherals. For example, bus 214 can provide high speed communication across cores and can also connect cores 202 with other units, such as the off-chip memory or peripherals. Typically, if there is a peripheral interface 212 (e.g., the inter-chip bus), bus 214 is solely concerned with intra-chip buses, though in some implementations it could still be concerned with specialized inter-bus communications.

Accelerator architecture 200 can also communicate with a host unit 220. Host unit 220 can be one or more processing unit (e.g., an X86 central processing unit). As shown in FIG. 2A, host unit 220 may be associated with host memory 221. In some embodiments, host memory 221 may be an integral memory or an external memory associated with host unit 220. In some embodiments, host memory 221 may comprise a host disk, which is an external memory configured to provide additional memory for host unit 220. Host memory 221 can be a double data rate synchronous dynamic random-access memory (e.g., DDR SDRAM) or the like. Host memory 221 can be configured to store a large amount of data with slower access speed, compared to the on-chip memory integrated within accelerator chip, acting as a higher-level cache. The data stored in host memory 221 may be transferred to accelerator architecture 200 to be used for executing neural network models.

In some embodiments, a host system having host unit 220 and host memory 221 can comprise a compiler (not shown). The compiler is a program or computer software that transforms computer codes written in one programming language into instructions for accelerator architecture 200 to create an executable program. In machine learning applications, a compiler can perform a variety of operations, for example, pre-processing, lexical analysis, parsing, semantic analysis, conversion of input programs to an intermediate representation, initialization of a neural network, code optimization, and code generation, or combinations thereof. For example, the compiler can compile a neural network to generate static parameters, e.g., connections among neurons and weights of the neurons.

In some embodiments, host system including the compiler may push one or more commands to accelerator architecture 200. As discussed above, these commands can be further processed by command processor 204 of accelerator architecture 200, temporarily stored in an instruction buffer of accelerator architecture 200, and distributed to corresponding one or more cores (e.g., cores 202 in FIG. 2A) or processing elements. Some of the commands may instruct a DMA unit (e.g., DMA unit 208 of FIG. 2A) to load instructions and data from host memory (e.g., host memory 221 of FIG. 2A) into accelerator architecture 200. The loaded instructions may then be distributed to each core (e.g., core 202 of FIG. 2A) assigned with the corresponding task, and the one or more cores may process these instructions.

It is appreciated that the first few instructions received by the cores 202 may instruct the cores 202 to load/store data from host memory 221 into one or more local memories of the cores (e.g., local memory 2032 of FIG. 2B). Each core 202 may then initiate the instruction pipeline, which involves fetching the instruction (e.g., via a sequencer) from the instruction buffer, decoding the instruction (e.g., via a DMA unit 208 of FIG. 2A), generating local memory addresses (e.g., corresponding to an operand), reading the source data, executing or loading/storing operations, and then writing back results.

According to some embodiments, accelerator architecture 200 can further include a global memory (not shown) having memory blocks (e.g., 4 blocks of 8 GB second generation of high bandwidth memory (HBM2)) to serve as main memory. In some embodiments, the global memory can store instructions and data from host memory 221 via DMA unit 208. The instructions can then be distributed to an instruction buffer of each core assigned with the corresponding task, and the core can process these instructions accordingly.

In some embodiments, accelerator architecture 200 can further include a memory controller (not shown) configured to manage reading and writing of data to and from a specific memory block (e.g., HBM2) within global memory. For example, the memory controller can manage read/write data coming from core of another accelerator (e.g., from DMA unit 208 or a DMA unit corresponding to the another accelerator) or from core 202 (e.g., from a local memory in core 202). It is appreciated that more than one memory controller can be provided in accelerator architecture 200. For example, there can be one memory controller for each memory block (e.g., HBM2) within global memory.

The memory controller can generate memory addresses and initiate memory read or write cycles. The memory controller can contain several hardware registers that can be written and read by the one or more processors. The registers can include a memory address register, a byte-count register, one or more control registers, and other types of registers. These registers can specify some combination of the source, the destination, the direction of the transfer (reading from the input/output (I/O) device or writing to the I/O device), the size of the transfer unit, the number of bytes to transfer in one burst, or other typical features of memory controllers.

While accelerator architecture 200 of FIG. 2A can be used for convolutional neural networks (CNNs) in some embodiments of the present disclosure, it is appreciated that accelerator architecture 200 of FIG. 2A can be utilized in various neural networks, such as deep neural networks (DNNs), recurrent neural networks (RNNs), or the like. In addition, some embodiments can be configured for various processing architectures, such as neural network processing units (NPUs), graphics processing units (GPUs), field programmable gate arrays (FPGAs), tensor processing units (TPUs), application-specific integrated circuits (ASICs), any other types of heterogeneous accelerator processing units (HAPUs), or the like

FIG. 2B illustrates an exemplary core architecture, consistent with embodiments of the present disclosure. As shown in FIG. 2B, core 202 can include one or more operation units such as first and second operation units 2020 and 2022, a memory engine 2024, a sequencer 2026, an instruction buffer 2028, a constant buffer 2030, a local memory 2032, or the like.

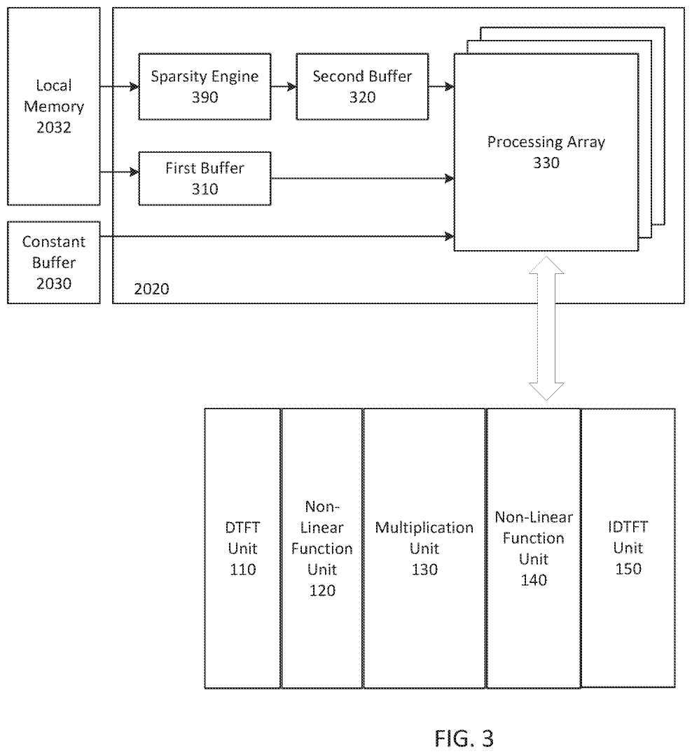

First operation unit 2020 can be configured to perform operations on received data (e.g., matrices). In some embodiments, first operation unit 2020 can include one or more processing units configured to perform one or more operations (e.g., multiplication, complex multiplication, addition, multiply-accumulate, element-wise operation, etc.). In some embodiments, first operation unit 2020 is configured to accelerate execution of convolution operations or matrix multiplication operations. An example of first operation unit 2020 will be explained with respect to FIG. 3 in detail.

Second operation unit 2022 can be configured to perform a pooling operation, an interpolation operation, a region-of-interest (ROI) operation, and the like. In some embodiments, second operation unit 2022 can include an interpolation unit, a pooling data path, and the like. In some embodiments, second operation unit 2022 can be configured to cooperate with first operation unit 2020 to perform the functions of non-linear function unit 120 or non-linear function unit 140. In various embodiments, as disclosed below with regards to FIG. 3, the functions of non-linear function unit 120 and non-linear function unit 140 can be performed by first operation unit 2020.

Memory engine 2024 can be configured to perform a data copy within a corresponding core 202 or between two cores. DMA unit 208 can assist with copying data within a corresponding core or between two cores. For example, DMA unit 208 can support memory engine 2024 to perform data copy from a local memory (e.g., local memory 2032 of FIG. 2B) into a corresponding operation unit. Memory engine 2024 can also be configured to perform matrix transposition to make the matrix suitable to be used in the operation unit.

Sequencer 2026 can be coupled with instruction buffer 2028 and configured to retrieve commands and distribute the commands to components of core 202. For example, sequencer 2026 can distribute convolution commands or multiplication commands to first operation unit 2020, distribute pooling commands to second operation unit 2022, or distribute data copy commands to memory engine 2024. Sequencer 2026 can also be configured to monitor execution of a neural network task and parallelize sub-tasks of the neural network task to improve efficiency of the execution. In some embodiments, first operation unit 2020, second operation unit 2022, and memory engine 2024 can run in parallel under control of sequencer 2026 according to instructions stored in instruction buffer 2028.

Instruction buffer 2028 can be configured to store instructions belonging to the corresponding core 202. In some embodiments, instruction buffer 2028 is coupled with sequencer 2026 and provides instructions to the sequencer 2026. In some embodiments, instructions stored in instruction buffer 2028 can be transferred or modified by command processor 204.

Constant buffer 2030 can be configured to store constant values. In some embodiments, constant values stored in constant buffer 2030 can be used by operation units such as first operation unit 2020 or second operation unit 2022 for batch normalization, quantization, de-quantization, or the like.

Local memory 2032 can provide storage space with fast read/write speed. To reduce possible interaction with a global memory, storage space of local memory 2032 can be implemented with large capacity. With the massive storage space, most of data access can be performed within core 202 with reduced latency caused by data access. In some embodiments, to minimize data loading latency and energy consumption, SRAM (static random access memory) integrated on chip can be used as local memory 2032. In some embodiments, local memory 2032 can have a capacity of 192MB or above. According to some embodiments of the present disclosure, local memory 2032 be evenly distributed on chip to relieve dense wiring and heating issues.

FIG. 2C illustrates a schematic diagram of an exemplary cloud system incorporating accelerator architecture 200, consistent with embodiments of the present disclosure. As shown in FIG. 2C, cloud system 230 can provide a cloud service with artificial intelligence (AI) capabilities and can include a plurality of computing servers (e.g., 232 and 234). In some embodiments, a computing server 232 can, for example, incorporate a neural network accelerator architecture 200 of FIG. 2A. Neural network accelerator architecture 200 is shown in FIG. 2C in a simplified manner for simplicity and clarity.

With the assistance of neural network accelerator architecture 200, cloud system 230 can provide the extended AI capabilities of image recognition, facial recognition, translations, 3D modeling, and the like. It is appreciated that, neural network accelerator architecture 200 can be deployed to computing devices in other forms. For example, neural network accelerator architecture 200 can also be integrated in a computing device, such as a smart phone, a tablet, and a wearable device.

FIG. 3 illustrates an exemplary operation unit configuration, consistent with embodiments of the present disclosure. According to embodiments of the present disclosure, operation unit 2020 can be a first operation unit (e.g., first operation unit 2020 in FIG. 2). Operation unit 2020 may include a first buffer 310, a second buffer 320, and a processing array 330.

First buffer 310 may be configured to store input data (e.g., input data 101 in FIG. 1). In some embodiments, data stored in first buffer 310 can be input data used by processing array 330 (e.g., Spatial-Domain Input Data 101 in FIG. 1). In some embodiments, the input data can be fetched from local memory (e.g., local memory 2032 in FIG. 2B). First buffer 310 may be configured to support reuse or sharing of data to be used in processing array 330. In some embodiments, input data stored in first buffer 310 may be used by processing array 330 for a convolution operation (which may be implemented as elementwise multiplication in the frequency domain, consistent with disclosed embodiments).

Second buffer 320 may be configured to store weights data (e.g., Spatial-Domain Kernel Data 102 in FIG. 1). In some embodiments, weights data stored in second buffer 320 can be used by processing array 330 for a convolution operation. In some embodiments, the weights data stored in second buffer 320 can be fetched from local memory (e.g., local memory 2032 in FIG. 2B).

According to some embodiments of the present disclosure, weights data stored in second buffer 320 can be compressed data. For example, weights data can be pruned data to save on-chip memory space. In some embodiments, operation unit 2020 can further include a sparsity engine 390. Sparsity engine 390 can be configured to unzip compressed weights data to be used by processing array 330.

Processing array 330 may have a plurality of layers (e.g., corresponding to a number of separate weight matrices). According to embodiments of the present disclosure, a first layer of processing array 330 may include components described in FIG. 1. For example, the first layer can include at least one of the DTFT unit 110, non-linear function unit 120, multiplication unit 130, non-linear function unit 140, and IDTFT unit 150. While computations performed by processing array 330 will be explained with respect to operations of FIG. 1 as an example for illustration purposes, it will be appreciated that the present disclosure is not limited to the example illustrated in FIG. 1.

In some embodiments, DTFT unit 110 can be configured to convert input data received from first buffer 310 into the frequency domain. In some embodiments, DTFT unit 110 can be configured to further convert weights data received from second buffer 320 into the frequency domain. In various embodiments, weights data may be obtained in the frequency domain (e.g., when neural network accelerator architecture 200 is used for an inference task). In such embodiments, weights data may be stored in second buffer 320 without conversion by DTFT 110 (or may be converted once by DTFT 110 and then stored). Non-linear function unit 120 can be configured to perform non-linear operations, such as those described herein, on the converted input data. Multiplication unit 130 can be configured to perform pointwise complex multiplication of elements in the matrix of frequency-domain input data and elements in the matrix of frequency domain weights. Multiplication unit 130 can be configured to perform complex multiplication of multiple elements in parallel. Non-linear function unit 140 can be configured to perform non-linear operations, such as those described herein, on the output of multiplication unit 130. IDTFT unit 150 can be configured to convert the frequency domain output into spatial domain output. In some embodiments, the first layer of processing array 330 can lack (or be configured not to use) one or more of DTFT unit 110, non-linear function unit 120, non-linear function unit 140, or IDTFT unit 150.

According to embodiments of the present disclosure, the other layers of processing array 330 can be similarly configured to perform functions similar to the first layer of processing array 330. For example, each of the other layers can also include components described in FIG. 1, which may be configured to generate output data using frequency space operations, as described herein.

In some embodiments, processing array 330 can perform computations under SIMD control. For example, when generating output using frequency domain operations (e.g., illustrated in FIG. 1), each layer of processing array 330 can execute the same instructions with different data. In the example illustrated in FIG. 1, each layer of processing array 330 can receive the input data and differing weights data. Each layer can process the input data using the received, differing weights data to generate different output data.

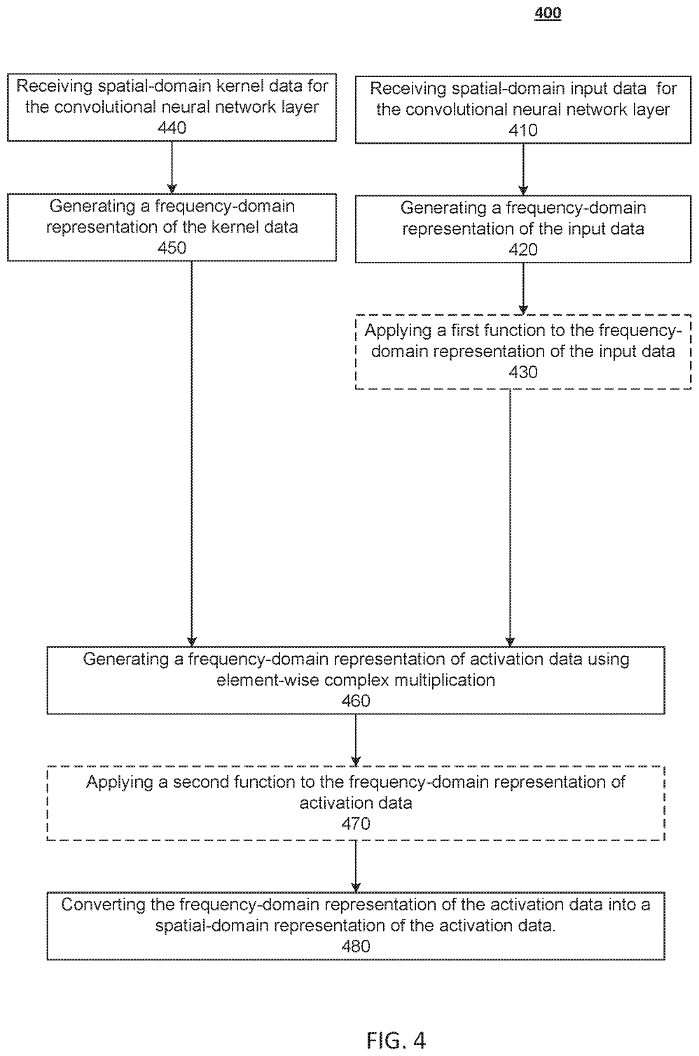

FIG. 4 illustrates an exemplary method 400 for generating a neural network layer output using frequency domain operations, in accordance with disclosed embodiments. Method 400 can include operations of receiving input and weights data, converting the input and weights data to the frequency domain, performing elementwise multiplication of the converted input and weights data, and converting the result of such multiplication to the spatial domain. In some embodiments, method 400 can further include applying the frequency domain input data to a non-linear function. In various embodiments, method 400 can further include applying the output of the elementwise multiplication to a non-linear function.

In operation 410, a hardware accelerator (e.g., CNN accelerator 100) can obtain spatial domain-input data for a convolutional neural network layer. The data can be obtained from another hardware accelerator, another component of the hardware accelerator (e.g., another core of the hardware accelerator). The data can be obtained from a memory, such as a core memory, a memory of the hardware accelerator, or a memory of a host system connected to the hardware accelerator. The data can be training data or inference data. The data can be a matrix of real-valued input data.

In operation 420, the hardware accelerator can convert the spatial-domain input data into a frequency-domain representation of the input data. The hardware accelerator can be configured to use a software-configurable FFT block to convert the spatial-domain input data into frequency-domain input data. The software-configurable FFT block can accept input data of varying size, dependent on the configuration of the FFT block. Conversion can include changing a dimension of the input data. For example, one or more dimensions of the input data can be increased, using zero padding or resampling of the input data. In some embodiments, a size of the increased dimensions can depend on a size of the input data and the weights data. In some instances, the size of an increased dimension of the data (e.g., row or column) can be the sum of the corresponding dimensions of the input data and the weights data, minus one. The frequency domain data can be complex-valued data.

In optional operation 430, the hardware accelerator can apply the frequency-domain input data to a non-linear function. For example, one or more peripheral rows or columns (e.g., corresponding to lower spatial frequencies) could be removed from the frequency-domain input data or set to zero. As an additional example, a pooling or dropout function could be applied to the frequency-domain input data. As a further example, a frequency-domain activation function, or a frequency-domain representation of a spatial-domain activation function, can be applied to the input data. In some embodiments, method 400 may not include operation 430.

In operation 440, the hardware accelerator can obtain spatial-domain weights data for the convolutional neural network layer. Similar to the spatial-domain input data, the weights data can be obtained from another hardware accelerator, another component of the hardware accelerator (e.g., another core of the hardware accelerator). The weights data can be obtained from a memory, such as a core memory, a memory of the hardware accelerator, or a memory of a host system connected to the hardware accelerator. The weights data can be fixed, when the hardware accelerator is used in an inference mode, or can vary during training, when the hardware accelerator is used in a training mode. The weights data can be a matrix of real-valued data.

In operation 450, the hardware accelerator can convert the spatial-domain weights data into a frequency-domain representation of the weights data. The hardware accelerator can be configured to use a software-configurable FFT block to convert the spatial-domain weights data into frequency-domain weights data. The software-configurable FFT block can be the same FFT block used to convert the input data, or a different FFT block. The software-configurable FFT block can accept weights data of varying size, dependent on the configuration of the FFT block. Conversion can include changing a dimension of the weights data. For example, one or more dimensions of the weights data can be increased, using zero padding or resampling of the weights data. In some embodiments, a size of the increased dimensions can depend on a size of the input data and the weights data. In some instances, the size of a increased dimension of the data (e.g., row or column) can be the sum of the corresponding dimensions of the input data and the weights data, minus one.

In operation 460, the hardware accelerator can perform element-wise multiplication of the frequency-domain input data and the frequency-domain weights data. The hardware accelerator can use a multiplication unit configured for complex multiplication. The multiplication unit can be configured to perform the multiplication in a single step. The multiplication unit can be implemented as a SIMD unit and can process multiplication of multiple elements in parallel.

In optional operation 470, the hardware accelerator can apply the output of the multiplication unit to a non-linear function to generate frequency-domain activation data. The non-linear function can be the same non-linear function as in operation 430, or a different non-linear function. For example, one or more peripheral rows or columns (e.g., corresponding to lower spatial frequencies) could be set to zero or removed from the output of the multiplication unit. As an additional example, a pooling or dropout function could be applied to the output of the multiplication unit. As a further example, a frequency-domain activation function, or a frequency-domain representation of a spatial-domain activation function, can be applied to the output of multiplication unit. In some implementations, the output of the non-linear function can be activation data. In some embodiments, method 400 may not include operation 470.

In operation 480, the hardware accelerator can convert the frequency-domain activation data into a spatial-domain representation of the activation data. In some implementations, the hardware accelerator can be configured to use a software-configurable FFT block to convert the frequency-domain activation data into spatial-domain activation data. The software-configurable FFT block can accept activation data of varying size, dependent on the configuration of the FFT block. The FFT block can be the same as the FFT block used to convert the weights data or as the FFT block used to convert the input data, or a different FFT block. The disclosed embodiments are not limited to those using an FFT block to convert the activation data to the spatial domain.

In some embodiments, the hardware accelerator may receive input data in the frequency domain, in which case operations 420 and 450 may not be performed. In some embodiments, the hardware accelerator may provide output data in the frequency domain, in which case operation 480 may not be performed. In some embodiments, the hardware accelerator may use previously obtained frequency-domain weights data (e.g., during inference), in which case operations 440 and 450 may not be performed. For example, the weights may be determined through a training task. The weights may be converted to the frequency domain and stored in hardware accelerator 200 (e.g., in second memory 320). The stored weights may then be used in method 400, without performance of operation 450. In various embodiments, the hardware accelerator may be configured to generate multiple layers using differing weight matrices. In such embodiments, the frequency-domain input data may be stored from generation of a prior output, in which case operations 410 to 430 may not be performed.

Embodiments herein include database systems, methods, and tangible non-transitory computer-readable media. The methods may be executed, for example, by at least one processor that receives instructions from a tangible non-transitory computer-readable storage medium (such as of a host system having host unit 220 and host memory 221 of FIG. 2A). Similarly, systems consistent with the present disclosure may include at least one processor and memory, and the memory may be a tangible non-transitory computer-readable storage medium. As used herein, a tangible non-transitory computer-readable storage medium refers to any type of physical memory on which information or data readable by at least one processor may be stored. Examples include random access memory (RAM), read-only memory (ROM), volatile memory, non-volatile memory, hard drives, CD ROMs, DVDs, flash drives, disks, registers, caches, and any other known physical storage medium. Singular terms, such as “memory” and “computer-readable storage medium,” may additionally refer to multiple structures, such a plurality of memories or computer-readable storage media. As referred to herein, a “memory” may comprise any type of computer-readable storage medium unless otherwise specified. A computer-readable storage medium may store instructions for execution by at least one processor, including instructions for causing the processor to perform steps or stages consistent with embodiments herein. Additionally, one or more computer-readable storage media may be utilized in implementing a computer-implemented method. The term “non-transitory computer-readable storage medium” should be understood to include tangible items and exclude carrier waves and transient signals.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

The embodiments may further be described using the following clauses:

1. A device, comprising: a convolutional neural network hardware accelerator configured to generate activation data from spatial-domain input data and spatial-domain weights data using frequency-domain operations, the convolutional neural network hardware accelerator comprising: one or more discrete Fourier transform units including circuitry configured to generate a frequency-domain representation of the input data; a multiplication unit including circuitry configured to generate a frequency-domain representation of the activation data by element-wise complex multiplication of the frequency-domain representation of the input data and a frequency-domain representation of the weights data; and an inverse discrete Fourier transform unit including circuitry configured to generate a spatial-domain representation of the activation data from the frequency-domain representation of the activation data.

2. The device of clause 1, wherein the convolutional neural network hardware accelerator further comprises: a first non-linear function unit including circuitry configured to apply a first function to the frequency-domain representation of the input data; or a second non-linear function unit including circuitry configured to apply a second function to the frequency-domain representation of the activation data.

3. The device of any one of clauses 1 to 2, wherein: the convolutional neural network hardware accelerator further includes the second non-linear function unit and the second function comprises a frequency-domain version of a rectified linear unit function, a sigmoid function, Exponential Linear Unit, Rectified Linear Unit, leaky Rectified Linear Unit, or hyperbolic tangent functions.

4. The device of any one of clauses 1 to 2, wherein: the convolutional neural network hardware accelerator further includes the second non-linear function unit and the second function comprises high-pass filtering the frequency-domain representation of the activation data.

5. The device of any one of clauses 1 to 4, wherein: the circuitry of the multiplication unit is configured to perform multiplication of two complex numbers in a single operation.

6. The device of clause 5, wherein: the multiplication unit includes an SIMD processor.

7. The device of any one of clauses 1 to 6, wherein: the circuitry of the one or more discrete Fourier transform units is further configured to generate the frequency-domain representation of the weights data.

8. The device of clause 7, wherein: the circuitry of the one or more discrete Fourier transform units is further configured to: generate the frequency-domain representation of the weight data at least in part by zero-padding the weight data; and generate the frequency-domain representation of the input data at least in part by zero-padding the input data.

9. The device of any one of clauses 1 to 8, wherein: a size of the frequency-domain representation of the input data depends on a size of the spatial-domain representation of the input data and a size of the spatial-domain representation of the weight data.

10. The device of any one of clauses 1 to 9, wherein: an input size of the one or more discrete Fourier transform units and of the inverse discrete Fourier transform unit is software-configurable to accept varying input sizes.

11. A method for calculating activation data for a convolutional neural network layer using frequency-domain operations, the method comprising: obtaining, by a hardware accelerator, spatial-domain input data and spatial-domain weight data for the convolutional neural network layer; converting, by the hardware accelerator, the spatial-domain input data and spatial-domain weight data into a frequency-domain representation of the input data and a frequency-domain representation of the weight data; generating, by the hardware accelerator, a frequency-domain representation of activation data by element-wise complex multiplication of the frequency-domain representation of the input data and the frequency-domain representation of the weight data; and converting, by the hardware accelerator, the frequency-domain representation of the activation data into a spatial-domain representation of the activation data.

12. The method of clause 11, the method further comprising: applying, by the hardware accelerator, a first function to the frequency-domain representation of the input data; or applying, by the hardware accelerator, a second function to the frequency-domain representation of the activation data.

13. The method of clause 12, wherein: wherein the method further includes applying the second function and the second function comprises a frequency-domain representation of a spatial-domain rectified linear unit function, sigmoid function, Exponential Linear Unit, Rectified Linear Unit, leaky Rectified Linear Unit, or hyperbolic tangent function.

14. The method of clause 12, wherein: wherein the method further applying the second function and the second function comprises high-pass filtering the frequency-domain representation of the activation data.

15. The method of any one of clauses 11 to 14, wherein: the element-wise complex multiplication is performed in a single operation.

16. The method of any one of clauses 11 to 15, wherein: converting the spatial-domain weight data into a frequency-domain representation of the weight data comprises zero-padding the weight data.

17. The method of any one of clauses 11 to 16, wherein: a size of the frequency-domain representation of the input data depends on a size of the spatial-domain representation of the input data and a size of the spatial-domain representation of the weight data.

18. The method of any one of clauses 11 to 17, wherein: a discrete Fourier transform unit of the hardware accelerator includes circuitry configured to convert the spatial-domain input data; and the method further comprises providing instructions to change an input size of the discrete Fourier transform unit based on an input size of the spatial-domain input data.

19. A system, comprising: a host device; and a convolutional neural network hardware accelerator configured, at least in part by the host device, to generate activation data from spatial-domain input data and spatial-domain weights data using frequency-domain operations, the convolutional neural network hardware accelerator comprising: one or more discrete Fourier transform units including circuitry configured to generate a frequency-domain representation of the input data; a multiplication unit including circuitry configured to generate a frequency-domain representation of the activation data by element-wise complex multiplication of the frequency-domain representation of the input data and a frequency-domain representation of the weights data; an inverse discrete Fourier transform unit including circuitry configured to generate a spatial-domain representation of the activation data from the frequency-domain representation of the activation data; and a first non-linear function unit including circuitry configured to apply a first function to the frequency-domain representation of the input data; or a second non-linear function unit including circuitry configured to apply a second function to the frequency-domain representation of the activation data.

20. A non-transitory computer-readable medium comprising instructions that, when executed by a convolutional neural network hardware accelerator, cause the convolutional neural network hardware accelerator to perform operations comprising: obtaining, by the convolutional neural network hardware accelerator, spatial-domain input data and spatial-domain weight data for a convolutional neural network layer; converting, by a discrete Fourier transform unit of the convolutional neural network hardware accelerator, the spatial-domain input data and spatial-domain weight data into a frequency-domain representation of the input data and a frequency-domain representation of the weight data; generating, by a SIMD unit of the convolutional neural network hardware accelerator, a frequency-domain representation of intermediate data by element-wise complex multiplication of the frequency-domain representation of the input data and the frequency-domain representation of the weight data; generating, by a non-linear function unit of the convolutional neural network hardware accelerator, a frequency-domain representation of activation data by applying a second function to the frequency-domain representation of the intermediate data; and converting, by a inverse discrete Fourier transform unit of the convolutional neural network hardware accelerator, the frequency-domain representation of the activation data into a spatial-domain representation of the activation data.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A device, comprising:
a convolutional neural network hardware accelerator configured to generate activation data from spatial-domain input data and spatial-domain weights data using frequency-domain operations, the convolutional neural network hardware accelerator comprising:
one or more discrete Fourier transform units including circuitry configured to generate a frequency-domain representation of the input data;
a multiplication unit including circuitry configured to generate a frequency-domain representation of the activation data by element-wise complex multiplication of the frequency-domain representation of the input data and a frequency-domain representation of the weights data; and
an inverse discrete Fourier transform unit including circuitry configured to generate a spatial-domain representation of the activation data from the frequency-domain representation of the activation data.

2. The device of claim 1, wherein the convolutional neural network hardware accelerator further comprises:
a first non-linear function unit including circuitry configured to apply a first function to the frequency-domain representation of the input data; or
a second non-linear function unit including circuitry configured to apply a second function to the frequency-domain representation of the activation data.

3. The device of claim 1, wherein:
the convolutional neural network hardware accelerator further includes the second non-linear function unit and the second function comprises a frequency-domain version of a rectified linear unit function, a sigmoid function, Exponential Linear Unit, Rectified Linear Unit, leaky Rectified Linear Unit, or hyperbolic tangent functions.

4. The device of claim 1, wherein:
the convolutional neural network hardware accelerator further includes the second non-linear function unit and the second function comprises high-pass filtering the frequency-domain representation of the activation data.

5. The device of claim 1, wherein:
the circuitry of the multiplication unit is configured to perform multiplication of two complex numbers in a single operation.

6. The device of claim 5, wherein:
the multiplication unit includes an SIMD processor.

7. The device of claim 1, wherein:
the circuitry of the one or more discrete Fourier transform units is further configured to generate the frequency-domain representation of the weights data.

8. The device of claim 7, wherein:
the circuitry of the one or more discrete Fourier transform units is further configured to:
generate the frequency-domain representation of the weight data at least in part by zero-padding the weight data; and
generate the frequency-domain representation of the input data at least in part by zero-padding the input data.

9. The device of claim 1, wherein:
a size of the frequency-domain representation of the input data depends on a size of the spatial-domain representation of the input data and a size of the spatial-domain representation of the weight data.

10. The device of claim 1, wherein:
an input size of the one or more discrete Fourier transform units and of the inverse discrete Fourier transform unit is software-configurable to accept varying input sizes.

11. A method for calculating activation data for a convolutional neural network layer using frequency-domain operations, the method comprising:
obtaining, by a hardware accelerator, spatial-domain input data and spatial-domain weight data for the convolutional neural network layer;
converting, by the hardware accelerator, the spatial-domain input data and spatial-domain weight data into a frequency-domain representation of the input data and a frequency-domain representation of the weight data;
generating, by the hardware accelerator, a frequency-domain representation of activation data by element-wise complex multiplication of the frequency-domain representation of the input data and the frequency-domain representation of the weight data; and
converting, by the hardware accelerator, the frequency-domain representation of the activation data into a spatial-domain representation of the activation data.

12. The method of claim 11, the method further comprising:
applying, by the hardware accelerator, a first function to the frequency-domain representation of the input data; or
applying, by the hardware accelerator, a second function to the frequency-domain representation of the activation data.

13. The method of claim 12, wherein:
wherein the method further includes applying the second function and the second function comprises a frequency-domain representation of a spatial-domain rectified linear unit function, sigmoid function, Exponential Linear Unit, Rectified Linear Unit, leaky Rectified Linear Unit, or hyperbolic tangent function.

14. The method of claim 12, wherein:
wherein the method further applying the second function and the second function comprises high-pass filtering the frequency-domain representation of the activation data.

15. The method of claim 11, wherein:
the element-wise complex multiplication is performed in a single operation.

16. The method of claim 11, wherein:
converting the spatial-domain weight data into a frequency-domain representation of the weight data comprises zero-padding the weight data.

17. The method of claim 11, wherein:
a size of the frequency-domain representation of the input data depends on a size of the spatial-domain representation of the input data and a size of the spatial-domain representation of the weight data.

18. The method of claim 11, wherein:
a discrete Fourier transform unit of the hardware accelerator includes circuitry configured to convert the spatial-domain input data; and
the method further comprises providing instructions to change an input size of the discrete Fourier transform unit based on an input size of the spatial-domain input data.

19. A system, comprising:
a host device; and
a convolutional neural network hardware accelerator configured, at least in part by the host device, to generate activation data from spatial-domain input data and spatial-domain weights data using frequency-domain operations, the convolutional neural network hardware accelerator comprising:
one or more discrete Fourier transform units including circuitry configured to generate a frequency-domain representation of the input data;
a multiplication unit including circuitry configured to generate a frequency-domain representation of the activation data by element-wise complex multiplication of the frequency-domain representation of the input data and a frequency-domain representation of the weights data;
an inverse discrete Fourier transform unit including circuitry configured to generate a spatial-domain representation of the activation data from the frequency-domain representation of the activation data; and
a first non-linear function unit including circuitry configured to apply a first function to the frequency-domain representation of the input data; or
a second non-linear function unit including circuitry configured to apply a second function to the frequency-domain representation of the activation data.

20. A non-transitory computer-readable medium comprising instructions that, when executed by a convolutional neural network hardware accelerator, cause the convolutional neural network hardware accelerator to perform operations comprising:
obtaining, by the convolutional neural network hardware accelerator, spatial-domain input data and spatial-domain weight data for a convolutional neural network layer;
converting, by a discrete Fourier transform unit of the convolutional neural network hardware accelerator, the spatial-domain input data and spatial-domain weight data into a frequency-domain representation of the input data and a frequency-domain representation of the weight data;
generating, by a SIMD unit of the convolutional neural network hardware accelerator, a frequency-domain representation of intermediate data by element-wise complex multiplication of the frequency-domain representation of the input data and the frequency-domain representation of the weight data;
generating, by a non-linear function unit of the convolutional neural network hardware accelerator, a frequency-domain representation of activation data by applying a second function to the frequency-domain representation of the intermediate data; and
converting, by a inverse discrete Fourier transform unit of the convolutional neural network hardware accelerator, the frequency-domain representation of the activation data into a spatial-domain representation of the activation data.
